(19) United States
(12) Patent Application Publication
(10) Pub. No.: US 2019/0068781 A1
(43) Pub. Date: Feb. 28, 2019

(54) FACILITATING CROSS-REGIONAL ACCESS ACROSS NUMBER PORTABILITY ADMINISTRATION CENTER REGIONS - CROSS REGIONAL MUMP JOBS

(71) Applicant: Neustar, Inc., Sterling, VA (US)

(72) Inventor: Edward F. Barker, Reston, VA (US)

(21) Appl. No.: 15/690,186

(22) Filed: Aug. 29, 2017

(51) Int. Cl. H04M 3/42; G06F 3/0482; G06F 17/30

(52) U.S. Cl. CPC H04M 3/42144; H04M 3/42238; G06F 17/30029; G06F 3/0482; H04M 3/42297

(57) ABSTRACT

Systems and methods are described herein for managing access and performing various actions across multiple, distinct, NPAC regions or systems controlled by the Number Portability Administration Center (NPAC). In some embodiments, a cross regional manager (CRM), or other intermediate management and control system, communicates with each of the multiple, distinct NPAC regions (which include various NPAC systems). The cross regional manager may act as an interface or intermediary between a user device or other requesting system (e.g., a system of a telecommunications services provider, or TSP), a single NPAC region, and the other NPAC regions of the NPAC.

### CROSS REFERENCE TO RELATED APPLICATIONS

This application is related to U.S. application Ser. No. ______, titled FACILITATING CROSS-REGIONAL ACCESS ACROSS NUMBER PORTABILITY ADMINISTRATION CENTER REGIONS—CRM SINGLE ACCESS, and U.S. application Ser. No. ______, titled FACILITATING CROSS-REGIONAL ACCESS ACROSS NUMBER PORTABILITY ADMINISTRATION CENTER REGIONS—SPID MIGRATION, which are concurrently filed with the present application and hereby incorporated by reference in their entirety for all purposes.

### BACKGROUND

The Number Portability Administration Center, or NPAC, is a system that manages local number portability (LNP) within the United States. Local number portability manages and enables changes to call routing for a telephone number, such as from a default or initial routing path, to a new routing path. For example, when a user changes service providers, the user's telephone number is “ported” from a path associated with a previous service provider to a path associated with a current service provider, such that calls and messages placed to the user's number route to switches within the new service provider's network.

The local number portability system is managed by the NPAC as a set of seven, distinct, geographic regions. Within any one region, a single NPAC system manages the LNP process for telephone numbers that reside in that region. Thus, the LNP system within the US includes seven separate and distinct instances of the NPAC system, which do not communicate with one another. As a result, some Telecommunications Service Providers (TSPs) connect to just one NPAC, while others connect to some or all of the NPAC regions.

### BRIEF DESCRIPTION OF THE DRAWINGS

Embodiments of the disclosed technology will be described and explained through the use of the accompanying drawings.

FIG. 1 is a block diagram illustrating a suitable computing environment implementing a cross regional manager (CRM) to communicate with distinct NPAC regions.

FIG. 2 is a block diagram illustrating communication sessions between the cross regional manager and NPAC regions.

FIG. 3 a flow diagram illustrating a method for authorizing a user with access to multiple distinct NPAC regions.

FIG. 4 is a display diagram illustrating a graphical user interface (GUI) that presents information associated with access to multiple distinct NPAC regions.

FIG. 5 is a flow diagram illustrating a method for managing a global communication session for a user.

FIG. 6 is a block diagram illustrating management of SPID migrations via the cross regional manager.

FIG. 7 a flow diagram illustrating a method for performing a SPID migration at a single NPAC region.

FIG. 8 is a block diagram illustrating management of MUMP jobs via the cross regional manager.

FIG. 9 a flow diagram illustrating a method for performing MUMP jobs across multiple distinct NPAC regions.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

### Overview

Systems and methods are described herein for managing access and performing various actions across multiple, distinct, NPAC regions or systems controlled by the Number Portability Administration Center (NPAC). In some embodiments, a cross regional manager (CRM), or other intermediate management and control system, communicates with each of the multiple, distinct NPAC regions (which include various NPAC systems). The cross regional manager may act as an interface or intermediary between a user device or other requesting system (e.g., a system of a telecommunications services provider, or TSP), a single NPAC region, and the other NPAC regions of the NPAC.

For example, the cross regional manager facilitates the performance of actions and access provisioning for users to some or all NPAC regions, even though the NPAC regions themselves are distinct and cannot communicate with one another. The CRM may communicate with the different NPAC regions using various bi-directional communication protocols or sessions, enabling the CRM to cause actions to be performed at multiple NPAC regions and enabling the NPAC regions to send data and information to the CRM, among other benefits.

In some embodiments, the systems and methods provide a user associated with a telecommunications service provider (TSP) with access to multiple NPAC regions by receiving an access request at a first NPAC region that includes access credentials associated with a user submitting the request, authorizing the user to access the first NPAC region based on the access credentials, generating a communication session between the first NPAC region and a cross regional manager configured to communicate with all of the multiple NPAC regions, receiving an access request at a second NPAC region distinct from the first NPAC region that is associated with the user, querying, via the second NPAC region, a database of the cross regional manager to determine whether the user was authorized to access the first NPAC region, and authorizing the user to access the second NPAC region based on a determination that the user was authorized to access the first NPAC region.

In some embodiments, the systems and methods authorize an NPAC region to perform a service provider identification number (SPID) migration at the NPAC region, by receiving a request from the NPAC region to perform a SPID migration within a maintenance window that defines a time period for which SPID migration processes across all of the multiple, distinct, NPAC regions may occur, identifying a number of SPID migration processes scheduled within the maintenance window for all of the multiple, distinct, NPAC regions, and authorizing the NPAC region to perform the SPID migration within the maintenance window based on whether the number of SPID migration processes satisfies a threshold number of SPID migration processes.

In some embodiments, the systems and methods coordinate mass update and mass port (MUMP) jobs across multiple NPAC regions, by receiving information from a first NPAC region that indicates a MUMP job associated with a telecommunications services provider (TSP) has been requested to be performed on one or more NPAC systems within the first NPAC region, identifying, via a database of the cross regional manager, other NPAC regions associated with the telecommunications services provider, and transmitting instructions from the cross regional manager to the other NPAC regions to perform a similar MUMP job at each of the other NPAC regions.

Thus, in some embodiments, the systems and methods employ a cross regional manager to communicate with various distinct and/or communicatively isolated NPAC regions in order to provide single access points or interfaces for users to multiple NPAC regions, and in order to perform certain cross regional actions (e.g., SPID migrations, MUMP jobs, and so on) or activities across multiple NPAC regions, among other benefits.

Various embodiments of the system will now be described. The following description provides specific details for a thorough understanding and an enabling description of these embodiments. One skilled in the art will understand, however, that the system may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### Suitable Computing Environments

As described herein, the systems and methods facilitate providing global access to multiple, distinct NPAC regions to users via a single interface (e.g., an interface provided by a single NPAC region), and facilitate performing actions (e.g., SPID migrations, MUMP jobs) across the multiple, distinct NPAC regions in response to initiation requests received at one of the NPAC regions.

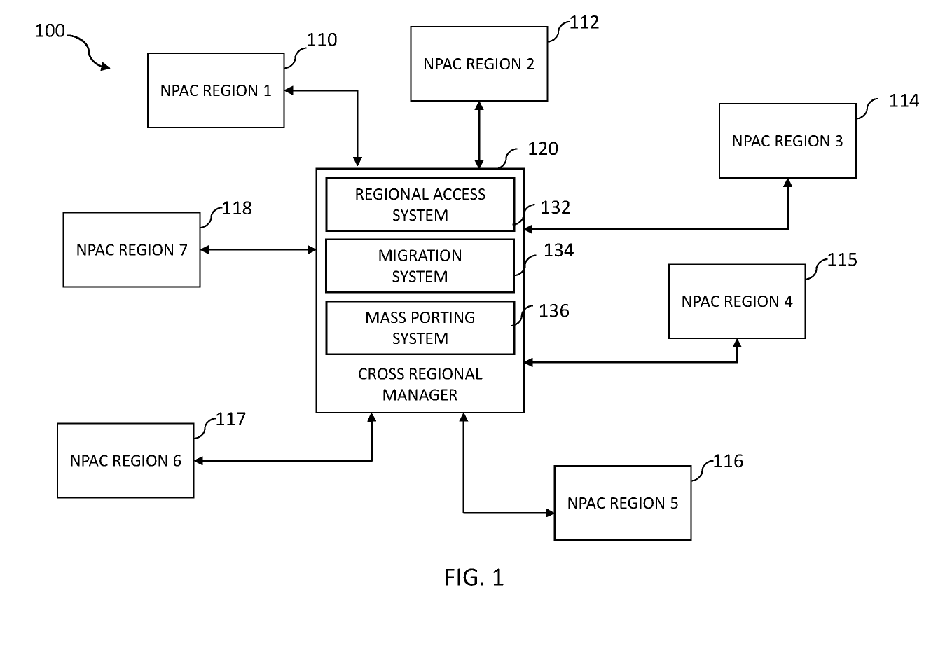

FIG. 1 is a block diagram illustrating a suitable computing environment 100 implementing a cross regional manager (CRM) to communicate with distinct NPAC regions. As described herein, local number portability is managed by the NPAC as a set of seven, distinct, geographic regions 110, 112, 114, 115, 116, 117, 118, shown as NPAC regions 1-7. For example, each of the regions may be assigned to a specific or distinct area or location. Within any one region, a single NPAC system manages the LNP process for telephone numbers that reside in that region. One NPAC region (e.g., NPAC region 1) is distinct from the other regions (e.g., NPAC region 3), and cannot communicate with the other regions. However, many telecommunications services providers, such as network carriers that provide communications networks, operate in multiple regions.

In order to facilitate multi-regional, or global (all region) access to the NPAC regions 110-118 for a TSP or other entity, the systems and methods include a cross regional manager (CRM) 120, which communicates with the different NPAC regions, and includes various systems configured to perform multi-regional and/or global actions across the different NPAC regions.

The cross regional manager 120 may include functional modules or systems that are implemented with a combination of software (e.g., executable instructions, or computer code) and hardware (e.g., at least a memory and processor). Accordingly, as used herein, in some examples a module is a processor-implemented module or set of code and represents a computing device having a processor that is at least temporarily configured and/or programmed by executable instructions stored in memory to perform one or more of the particular functions that are described herein. For example, the cross regional manager 120 includes a regional access system 132, a migration system 134, and a mass porting system 136.

In some embodiments, the regional access system 132 is configured and/or programmed to facilitate access for a user to NPAC systems at multiple different NPAC regions via a single interface, such as a graphical user interface (GUI) provided at one of the NPAC regions at which the user accesses the NPAC.

In some embodiments, the migration system 134 is configured and/or programmed to manage, control, authorize, and/or perform service provider identification number (SPID) migrations at one or more NPAC regions by tracking and managing the status or operation of SPID migrations and the various different NPAC regions.

In some embodiments, the mass porting system 136 is configured and/or programmed to manage, control, and/or coordinate mass update and mass port (MUMP) jobs across the multiple NPAC regions, such as MUMP jobs initiated at a single NPAC region.

Therefore, the cross regional manager 120, as described herein, provides various systems and performs various processes that enable various multi-regional and/or global actions to be performed, mitigating the structural and legal restrictions applied to the NPAC with respect to maintaining separate, isolated, and non-integrated regions, among other benefits. Further details regarding the systems of the cross regional manager 120 and the processes performed by the cross regional manager 120 are described herein.

FIG. 1 and the discussion herein provide a brief, general description of the components of the computing environment 100. Although not required, aspects of the computing environment 100 are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices (including tablet computers and/or personal digital assistants (PDAs)), all manner of cellular or mobile phones, (e.g., smart phones), multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the environment 100 can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the environment 100 may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system reside on a server computer, while corresponding portions reside on a client computer such as a mobile or portable device, and thus, while certain hardware platforms are described herein, aspects of the system are equally applicable to nodes on a network.

### Examples of Providing Single Access to Multiple NPAC Regions

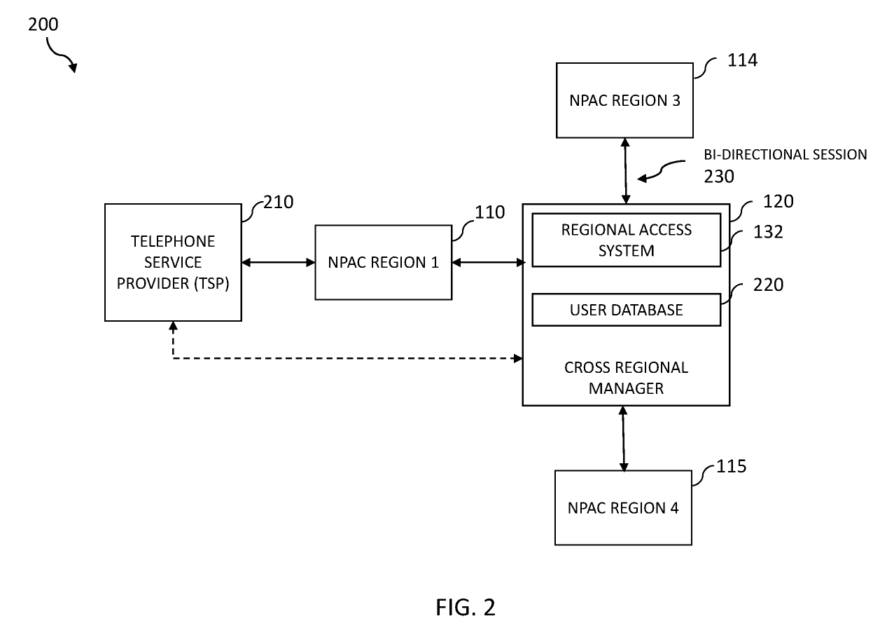

As described herein, the cross regional manager 120 provides a “single sign on” capability for users of multiple NPAC regions via user interfaces at the NPAC regions. FIG. 2 is a block diagram 200 illustrating communication sessions between the cross regional manager 120 and NPAC regions.

As described herein, the cross regional manager 120 includes a regional access system 132 that communicates with the multiple, distinct NPAC regions (e.g., NPAC region 1, NPAC region 3, and NPAC region 4, as shown) using bi-directional communication sessions 230 or protocols. Each of the NPAC regions, for example, manage local number portability processes for a distinct geographical region within the United States.

For example, an administrator of a TSP 210 attempts to access the NPAC region 110 via a user interface provided by the NPAC region 110. The NPAC region 110 receives user credentials (e.g., username and password) from the administrator via the interface, and authorizes the administrator to access various NPAC systems at the NPAC region 110.

The TSP 210, however, operates in many different NPAC regions, such as NPAC region 114 and NPAC region 115. Previously, in order to access the other regions given their communicative isolation from one another, the administrator would submit separate access requests (e.g., such as requests that include login information) to each NPAC region, and operate separate communication sessions with each NPAC regions.

However, the cross regional manager 120 facilitates authorization of the administrator to access one, some, or all of the seven NPAC regions at which the TSP operates, and establishes and maintains bi-directional communication sessions between the cross regional manager and the different NPAC regions to facilitate the multi-regional or global access to the NPAC regions for the user.

The regional access system 132, for example, may create, maintain, and/or modify files or other data structures within memory of the system, and/or within a user database 220 that includes entries that relate information identifying a TSP (and various associated users) to NPAC regions at which the TSP (or users) operate and/or are authorized to access. Table 1 depicts a simplified version of data structures within memory or the user database 220.

TABLE 1

| User | Authorized regions | Access Status |
|---|---|---|
| TSP34567_allusers | Reg_1, Reg_3, Reg_4 | Last access on |
| | | 2012 Mar. 12 |
| TSP34453_allusers | Reg_1, Reg_5, Reg_7 | Last access on |
| | | 2012 Mar. 13 |
| TSP456453_allusers | Reg_All | Active session |
| TSP11123_allusers | Reg_7 | Last access on |
| | | 2012 Mar. 9 |

As shown in the table, the database 220 may track user information, user group information, region authorization information, access timestamps and other status information, and so on.

Thus, in providing a single interface via which a user accesses multiple NPAC regions, the regional access system 132 may consolidate separate regional accounts into a single global account, with indicators for each region available to a user or group of users. Further, the CRM 120 facilitates bi-directional communication between the CRM and the NPAC regions.

In some embodiments, the CRM 120 may directly receive access requests from a TSP 210 to one or more of the NPAC regions, and manage communications between the TSP 210 and the requested NPAC regions. For example, the CRM 120 may provide a user interface that receives access request, including user credentials (e.g., username and password) from the administrator. The CRM 120 may then authorize the administrator to access various NPAC systems (e.g., the NPAC region 110) managed by the CRM 120.

Unlike conventional single interface mechanisms, where clients send messages to a server in an attempt to log in, but the server does not initiate messages to the clients, the CRM 120 maintains a persistent connection between the server (e.g., the CRM 120) and the clients (e.g., the NPAC region servers), enabling the CRM 120 to discover, monitor, track, and/or receive information about each region (e.g., a user's most recent activity in an NPAC region. Such functionality provides the CRM 120 with maintaining communication sessions for users across different NPAC regions, as described herein.

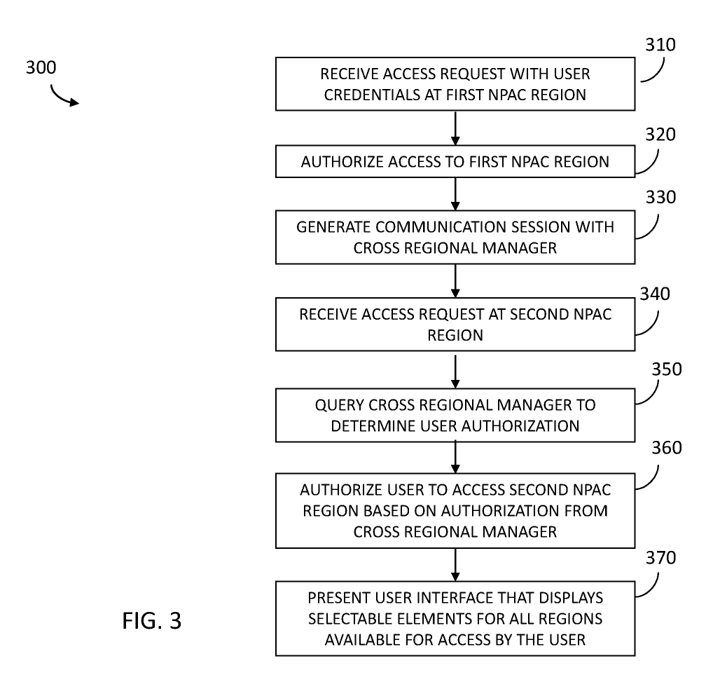

FIG. 3 a flow diagram illustrating a method 300 for authorizing a user with access to multiple distinct NPAC regions. Aspects of the method 300 may be performed by the regional access system 132 and, accordingly, is described herein merely by way of reference thereto. It will be appreciated that the method 300 may be performed on any suitable hardware.

In operation 310, a first NPAC region (or, the CRM 120 directly) receives an access request that includes access credentials associated with a user submitting the request. For example, the NPAC region 110 receives a request via a user interface from the TSP 210 to access various NPAC systems (e.g., call routing databases) at the NPAC region 110. In operation 320, the first NPAC region authorizes the request, and provides the user access to the NPAC systems at the region.

In operation 330, the first NPAC region generates a communication session with the cross regional manager (CRM), which is configured to communicate with all of the multiple NPAC regions.

In operation 340, a second NPAC region distinct from the first NPAC region receiving an access request. For example, the NPAC region 114 receives an access request from the TSP 210.

In operation 350, the system 132 queries a database of the cross regional manager 120 to determine whether the user was authorized to access the first NPAC region. For example, the system 132 queries the user database 220 to determine whether the user (e.g., an administrator of the TSP 210), was authorized at the NPAC region 110 and operates at the second NPAC region (e.g., region 114).

In operation 360, the system 132 authorizes the user to access the second NPAC region based on a determination that the user was authorized to access the first NPAC region. The system 132 may also authorize the user to other NPAC regions (e.g., NPAC region 115) for which the TSP 210 operates.

In operation 370, the system 132 presents via a user interface associated with the user, one or more user-selectable display elements associated with NPAC regions to which the user is authorized to access. For example, the system 132 may cause the user interface at the first NPAC region to present links that facilitate user access to NPAC systems at the NPAC regions for which the user may access.

In some cases, a region, in response to a user request (e.g. login request) to visit or access the region, sends a request to the system 132 to determine whether the user is part of a valid session within the CRM. When there is a valid session, the region authorizes the user to the region without requesting user credentials, else the region obtains credentials from the user, authenticates them, establishes a session, and updates the CRM with the session information for use by other regions.

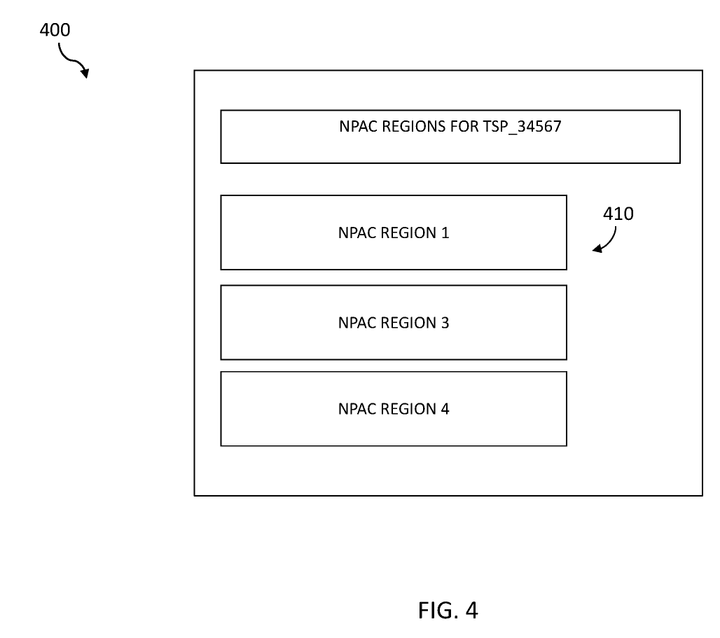

FIG. 4 is a display diagram illustrating a graphical user interface (GUI) 400 that presents information associated with access to multiple distinct NPAC regions. The GUI 400 presents various user-selectable elements 410, such as links, buttons, and so on, as well as various associated information (e.g., region description information, user status information, and so on. For example, the GUI 400 presents links to NPAC regions (e.g., regions 1, 3, 4) accessible to the user TSP_34567.

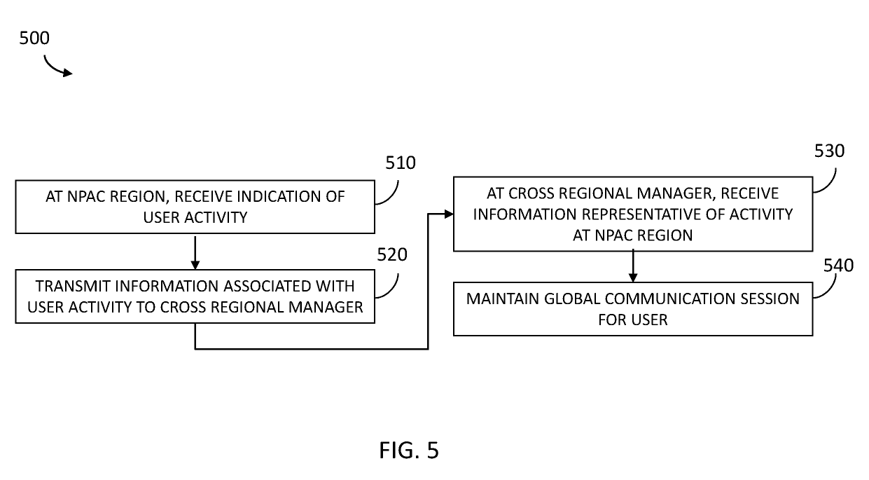

As described herein, in some embodiments, the cross regional manager 120 creates bi-directional communication sessions between the CRM 120 and the multiple, distinct, NPAC regions 110-118 to manage and maintain cross-regional communication sessions for a user. FIG. 5 is a flow diagram illustrating a method 500 for managing a global communication session for a user. Aspects of the method 500 may be performed by the cross regional manager 120 and, accordingly, is described herein merely by way of reference thereto. It will be appreciated that the method 500 may be performed on any suitable hardware.

In operation 510, an NPAC region receives an indication of user activity at the region. For example, the user may access a database, perform one or more database actions, perform one or more porting activities, and so on. In operation 520, the NPAC region transmits the activity information, or associated status information (e.g., user is “active” or “inactive”), to the cross regional manager 120.

In operation 530, the cross regional manager 120 receives the information from the NPAC region that indicates user activity at the NPAC region; and, in operation 540, maintains the user access to other NPAC regions (e.g., global access) for the user based on the user activity at the single NPAC region.

In some cases, the CRM 120 tracks activities per region in order to determine when to perform a cross-regional inactivity timeout for user sessions. For example, the CRM 120 may implement a security protocol or rule where, when a user is inactive for a certain period of time, their valid session is modified to being invalid or expired. However, because the CRM 120 tracks activities within all regions, a region may query the CRM 120 to determine whether the user is or was recently active in another region, before ending the user's session due to inactivity in the region.

Thus, the cross regional manager 120 performs various processes to optimize a user's access to multiple, distinct, NPAC regions (and systems therein), as well as to efficiently manage communications sessions between the user and the different NPAC regions, among other benefits.

Further, the CRM 120 provides a mechanism for sharing information between NPAC regions, which facilitates the performance of actions and other activities at one or multiple NPAC regions, even though the regions themselves are not connected and cannot communicate with one another.

### Examples of Performing SPID Migrations at an NPAC Region

As described herein, the migration system 134 may manage, control, authorize, and/or perform service provider identification number (SPID) migrations at one or more NPAC regions by tracking and managing the status or operation of SPID migrations and the various different NPAC regions. A SPID migration, for example, is a process performed at an NPAC region for updating data records associated with a transfer of ownership of a telecommunications network from a first service provider to a second service provider.

SPID Migration is a feature in the NPAC that supports the merger and acquisition activities of the TSP community. For example, when one company acquires the assets of another company, the NPAC is updated to reflect the new ownership of the network and associated items. The SPID migration process performs a batch update run during a maintenance window, which modifies various databases to reflect the new ownerships. However, the industry has imposed quotas on the number of migrations that can occur in any one maintenance window, and these quotas are imposed cross-regionally. Of course, other quotas may be imposed, such as the size of the migrations.

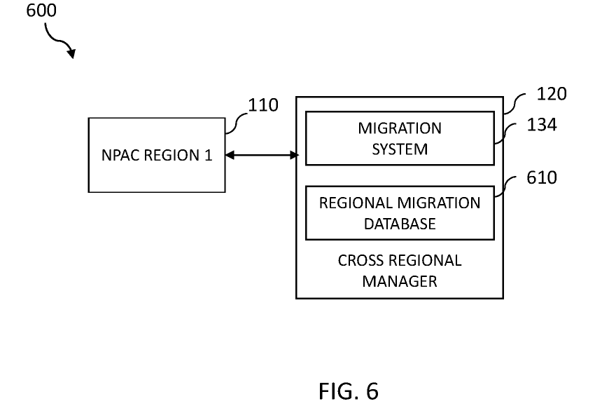

The cross regional manager 120 includes various components that manage the SPID migrations at the individual NPAC regions, assuring the NPAC and the NPAC regions comply with the quotas and do not exceed the allowed SPID migrations in a given maintenance window. FIG. 6 is a block diagram 600 illustrating management of SPID migrations via the cross regional manager.

As shown, the cross regional manager 120 interacts with the NPAC region 110 to manage SPID migrations at the NPAC region. The cross regional manager 120, via the migration system 134, accesses the various NPAC regions to obtain information regarding scheduled, pending, or current SPID migrations, and tracks the number or size of SPID migrations for the NPAC via one or more data structures stored in a regional migration database 610. Table 2 depicts a simplified version of data structures within the regional migration database.

TABLE 2

| NPAC Region | Number of SPID Migrations | Total size of Migrations |
|---|---|---|
| Region 1 | 3 migrations | 300 MB |
| Region 2 | 0 migrations | 0 MB |
| Region 3 | 2 migrations | 400 MB |
| Region 4 | 1 migration | 100 MB |
| Region 5 | 2 migrations | 200 MB |
| Region 6 | 7 migrations | 500 MB |
| Region 7 | 0 migrations | 0 MB |

As shown in Table 2, the regional migration database 610 may store, for a previous, current, or future maintenance window. information identifying an NPAC region, the scheduled or running number of migrations, and the expected or estimated size of the migrations. The size of a migration may be a total size of database records to be modified during the SPID migration, the size of records to be added or deleted, the size of records to be copied and/or archived, and so on.

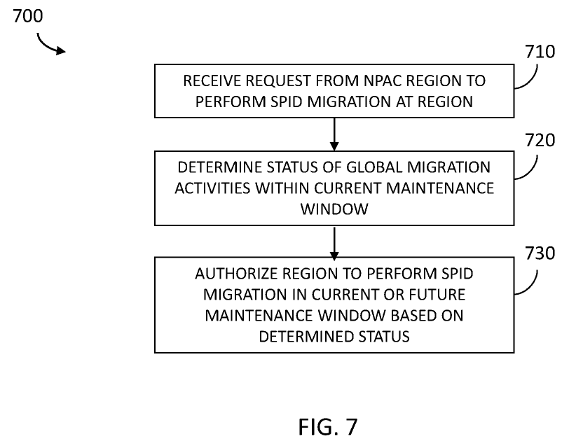

The migration system 134, therefore, is configured to perform various processes for managing SPID migrations for the NPAC. FIG. 7 a flow diagram illustrating a method 700 for performing a SPID migration at a single NPAC region. Aspects of the method 700 may be performed by the migration system 134 and, accordingly, is described herein merely by way of reference thereto. It will be appreciated that the method 700 may be performed on any suitable hardware.

In operation 710, the system 134 receives a request from the NPAC region to perform a SPID migration within a maintenance window that defines a time period for which SPID migration processes across all of the multiple, distinct, NPAC regions may occur.

Before receiving the request, the CRM 120 receives, retrieves, and/or obtains information from each of the multiple, distinct, NPAC regions that indicates scheduled SPID migration jobs for an NPAC region within the maintenance window, and stores the received information in a SPID migration jobs database (e.g., database 610).

In operation 720, the system 134 identifies a number of SPID migration processes scheduled within the maintenance window for all of the multiple, distinct, NPAC regions. The system 134 may identify, via information from database 610, a total number of SPID migration processes scheduled for each of the NPAC regions within the maintenance window and/or a total size of the scheduled SPID migration processes.

In operation 730, the system 134 authorizes the NPAC region to perform the SPID migration within the maintenance window based on whether the number of SPID migration processes satisfies a threshold number of SPID migration processes. The system 134 may authorize the NPAC to perform the SPID migration upon determining that a total number of SPID migration processes scheduled for a current maintenance window is below a threshold number that defines a total number of SPID migration processes allowed during the current maintenance window across all of the NPAC regions and/or upon determining that a job size associated with SPID migration processes scheduled for a current maintenance window is below a threshold job size that defines a total job size for SPID migration processes allowed during the current maintenance window across all of the NPAC regions.

In some cases, when the number of scheduled SPID migrations (or, total size of scheduled SPID migrations) exceeds threshold or quota amounts, the system 134 may deny they NPAC region the request to perform the SPID migration within the maintenance window. In doing so, the system 134 may provide information identifying the already scheduled SPID migrations.

Also, the system 134 may schedule (automatically or in response to user confirmation) the requested SPID migration for the next maintenance window, in order to ensure the SPID migration is performed as soon as is allowable. In some cases, for SPID migrations determined to have priority or having a large amount of records, the system 134 may schedule such SPID migrations over previously scheduled SPID migrations, in order to ensure high priority SPID migrations are completed.

The system, 134, therefore, may access the different regions to capture or determine metrics (e.g., counts, sizes, and so on) associated with performed SPID migrations at the regions, and/or may stage or provide data to the different regions and manage or coordinate performance of the SPID migrations.

Thus, the NPAC regions may include one or more systems that perform SPID migrations in association with the cross regional manager, by transmitting a request from the NPAC region to the cross regional manager to perform a SPID migration at the NPAC region within a maintenance window that defines a time period for which SPID migration processes across all of the multiple, distinct, NPAC regions may occur, receiving an authorization from the cross regional manager to perform the SPID migration within the maintenance window, and initiating the SPID migration at the NPAC region in response to the authorization received from the cross regional manager.

### Examples of Performing Porting Jobs Across NPAC Regions

As described herein, the cross regional manager manages, controls, and/or coordinates mass update and mass port (MUMP) jobs across the multiple NPAC regions, such as MUMP jobs initiated at a single NPAC region. MUMP is an NPAC feature that allows a TSP to initiate large scale new porting activities or portability records modifications. For example, a user creates a job that defines the actions to be taken with the regional system. A MUMP job, therefore, includes creating, modifying, or deleting number records within an NPAC system without using an interface associated with the TSP to the NPAC system.

Using the CRM 120 cross-regional functionality described herein, a user may define a MUMP job within a single NPAC region, and indicate the set of NPAC regions at which the job should also be performed. The defining NPAC region then shares the job details with the CRM 120, and the CRM 120 provides instructions to the other NPAC regions. The other NPAC regions create the job, where it is scheduled and executed.

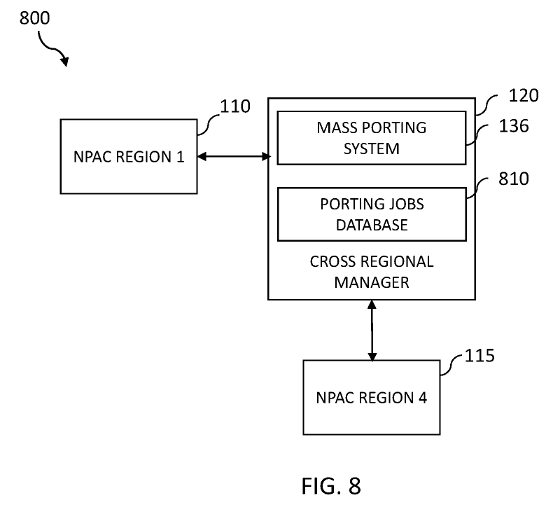

FIG. 8 is a block diagram 800 illustrating management of MUMP jobs via the cross regional manager. As shown, the mass porting system 136 is configured to receive MUMP job information from a single NPAC region 110, identify, via a porting jobs database 810, other NPAC regions 115 within which the MUMP job is to be performed (or, via instructions provided by the user), as well as NPAC regions at which the user operates, and cause the other NPAC regions to perform the MUMP jobs. For example, the mass porting system 136 may look to one or more data structures, such as Table 1, when identifying other NPAC regions at which to perform the MUMP job. The data structures, therefore, may include one or more entries, wherein each of the one or more entries includes information relating the TSP to NPAC regions associated with the TSP.

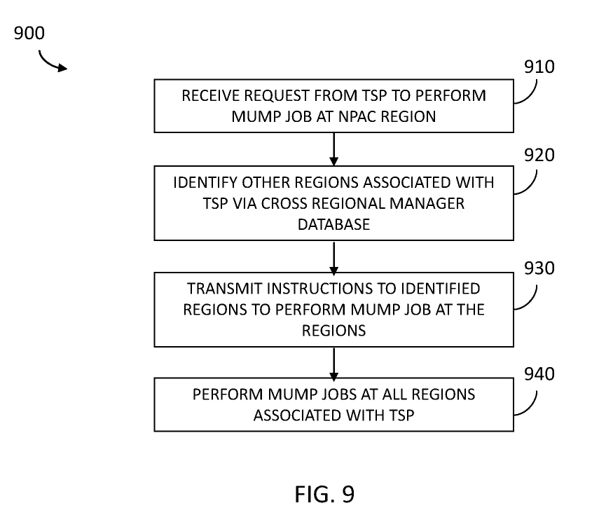

Thus, the system 136 may perform various processes when performing MUMP jobs on behalf of a user (e.g., a TCS administrator). FIG. 9 a flow diagram illustrating a method 900 for performing MUMP jobs across multiple distinct NPAC regions. Aspects of the method 900 may be performed by the mass porting system 136 and, accordingly, is described herein merely by way of reference thereto. It will be appreciated that the method 900 may be performed on any suitable hardware.

In operation 910, the system 136 receives information from a first NPAC region that indicates a MUMP job associated with a telecommunications services provider (TSP) has been requested to be performed on one or more NPAC systems within the first NPAC region. For example, a single NPAC region may receive a request from the TSP at to initiate a new porting activity within the one or more NPAC systems within the first NPAC region, where the request includes an identification of at least one additional NPAC region of the multiple NPAC regions at which to initiate the new porting activity.

In operation 920, the system 136 identifies, via a database of the cross regional manager, other NPAC regions associated with the telecommunications services provider. Similar to the interface depicted in FIG. 4, the system 136, in some cases, may present, via a user interface associated with the TSP, one or more user-selectable display elements associated with NPAC regions to which the TSP is associated, where the one or more user-selectable elements, when selected by the TSP, facilitate performance of the MUMP job at one or more of the other NPAC regions.

In operation 930, the system 136 transmits instructions from the cross regional manager to the other NPAC regions to perform a similar MUMP job at each of the other NPAC regions, and in operation 940, the other NPAC regions perform the MUMP job in response to receiving the instructions from the cross regional manager.

Of course, the cross regional manager may manage, control, and/or coordinate other porting jobs or NPAC transactions across the multiple NPAC regions. For example, the CRM 120 may facilitate operations of Inter-TSP porting jobs across multiple NPAC regions, operations of Intra-TSP porting jobs across multiple NPAC regions, activations of large sets of telephone numbers (e.g., a thousand block of numbers) across multiple NPAC regions, and/or other operations or actions to be performed in multiple different regions for a TSP 210 or other entity associated with the NPAC.

Thus, as described herein, the cross regional manager facilitates the performance of various actions across the compartmentalized NPAC based on requests or input received at a single NPAC region. As described herein, the cross regional manager limits the constraints imposed by the silo-like NPAC regions under control of the NPAC, enabling global or multi-regional access to the NPAC systems at multiple, distinct NPAC regions, as well as the performance of actions across different NPAC regions, among other benefits.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/We claim:

1. A method, performed by a cross regional manager (CRM) configured to communicate with multiple, distinct, national portability administration center (NPAC) regions, for coordinating mass update and mass port (MUMP) jobs across multiple NPAC regions, the method comprising:
receiving information from a first NPAC region that indicates a MUMP job associated with a telecommunications services provider (TSP) has been requested to be performed on one or more NPAC systems within the first NPAC region;
identifying, via a database of the cross regional manager, other NPAC regions associated with the telecommunications services provider; and
transmitting instructions from the cross regional manager to the other NPAC regions to perform a similar MUMP job at each of the other NPAC regions.

2. The method of claim 1, further comprising:
performing, at the other NPAC regions, the MUMP job in response to receiving the instructions from the cross regional manager.

3. The method of claim 1, wherein a MUMP job includes creating, modifying, or deleting number records within an NPAC system without using an interface associated with the TSP to the NPAC system.

4. The method of claim 1, wherein each of the NPAC regions are distinct from one another and configured to not communicate with one another.

5. The method of claim 1, wherein each of the NPAC regions manage local number portability processes for a distinct geographical region within the United States.

6. The method of claim 1, further comprising:
receiving a request from the TSP at the first NPAC region to initiate a new porting activity within the one or more NPAC systems within the first NPAC region,
wherein the request includes an identification of at least one additional NPAC region of the multiple NPAC regions at which to initiate the new porting activity.

7. The method of claim 1, wherein the database of the cross regional manager includes one or more entries, wherein each of the one or more entries includes information relating the TSP to NPAC regions associated with the TSP.

8. The method of claim 1, wherein the cross regional manager is configured to communicate with each of the NPAC regions over bi-directional communication sessions.

9. The method of claim 1, further comprising:
presenting, via a user interface associated with the TSP, one or more user-selectable display elements associated with NPAC regions to which the TSP is associated,
wherein the one or more user-selectable elements, when selected by the TSP, facilitate performance of the MUMP job at one or more of the other NPAC regions.

10. A non-transitory computer-readable medium whose contents, when executed by a cross regional manager configured to communicate with multiple, distinct, national portability administration center (NPAC) regions, cause the cross regional manager to perform a method for coordinating mass update and mass port (MUMP) jobs across the multiple NPAC regions, the method comprising:
receiving information from a first NPAC region that indicates a MUMP job associated with a telecommunications services provider (TSP) has been requested to be performed on one or more NPAC systems within the first NPAC region;
identifying, via a database of the cross regional manager, other NPAC regions associated with the telecommunications services provider; and
transmitting instructions from the cross regional manager to the other NPAC regions to perform a similar MUMP job at each of the other NPAC regions.

11. The non-transitory computer-readable medium of claim 10, further comprising:
performing, at the other NPAC regions, the MUMP job in response to receiving the instructions from the cross regional manager.

12. The non-transitory computer-readable medium of claim 10, wherein a MUMP job includes creating, modifying, or deleting number records within an NPAC system without using an interface associated with the TSP to the NPAC system.

13. The non-transitory computer-readable medium of claim 10, wherein each of the NPAC regions are distinct from one another and configured to not communicate with one another.

14. The non-transitory computer-readable medium of claim 10, wherein each of the NPAC regions manage local number portability processes for a distinct geographical region within the United States.

15. The non-transitory computer-readable medium of claim 10, further comprising:
receiving a request from the TSP at the first NPAC region to initiate a new porting activity within the one or more NPAC systems within the first NPAC region,
wherein the request includes an identification of at least one additional NPAC region of the multiple NPAC regions at which to initiate the new porting activity.

16. The non-transitory computer-readable medium of claim 10, wherein the database of the cross regional manager includes one or more entries, wherein each of the one or more entries includes information relating the TSP to NPAC regions associated with the TSP.

17. The non-transitory computer-readable medium of claim 10, wherein the cross regional manager is configured to communicate with each of the NPAC regions over bi-directional communication sessions.

18. The non-transitory computer-readable medium of claim 10, further comprising:
presenting, via a user interface associated with the TSP, one or more user-selectable display elements associated with NPAC regions to which the TSP is associated,
wherein the one or more user-selectable elements, when selected by the TSP, facilitate performance of the MUMP job at one or more of the other NPAC regions.

19. A system associated with a cross regional manager configured to communicate with multiple, distinct, national portability administration center (NPAC) regions, the system comprising:
at least one processor;
at least one data storage device coupled to the at least one processor and storing instructions for implementing a method for coordinating mass update and mass port (MUMP) jobs across the multiple NPAC regions, the method comprising:
receiving information from a first NPAC region that indicates a MUMP job associated with a telecommunications services provider (TSP) has been requested to be performed on one or more NPAC systems within the first NPAC region;
identifying, via a database of the cross regional manager, other NPAC regions associated with the telecommunications services provider; and
transmitting instructions from the cross regional manager to the other NPAC regions to perform a similar MUMP job at each of the other NPAC regions.

20. The system of claim 19, further comprising:
receiving a request from the TSP at the first NPAC region to initiate a new porting activity within the one or more NPAC systems within the first NPAC region,
wherein the request includes an identification of at least one additional NPAC region of the multiple NPAC regions at which to initiate the new porting activity.
